(19) United States
(12) Patent Application Publication
(10) Pub. No.: US 2026/0349072 A1
(43) Pub. Date: Nov. 5, 2026

(54) SIMULTANEOUS SENSING AND BACKSCATTER COMMUNICATION USING SENSING SIGNAL CODEBOOKS

(71) Applicant: KONINKLIJKE PHILIPS N.V., EINDHOVEN (NL)

(72) Inventors: Harry Michael Cronin, Zurich (CH); Nicholas Simon Walker, Zurich (CH); David Michael Duffy, Zurich (CH); Robert James Davies, Eindhoven (NL); Oscar Garcia Morchon, Eindhoven (NL)

(21) Appl. No.: 19/486,992

(22) PCT Filed: May 1, 2024
(86) PCT No.: PCT/EP2024/064989

§ 371 Date: Nov. 24, 2025

(30) Foreign Application Priority Data
Jun. 5, 2023 (EP) 23177410.0

(51) Int. Cl. G01S 7/00; G01S 7/35; G01S 13/58

(52) U.S. Cl. CPC G01S 7/006; G01S 7/356; G01S 13/584

(57) ABSTRACT

The invention proposes a system and method by which wide area backscatter communications can be enabled on top of an existing integrated sensing and communications (ISAC) waveform, without introducing Doppler ambiguities, by modifying waveform parameters such as the chirp start and stop frequencies between adjacent (or at least, groups of n) chirps according to a codebook.

### FIELD OF THE INVENTION

The invention relates to the fields of wireless sensing and backscatter communication in wireless networks, such as—but not limited to—radar-like chirp sequence applications.

### BACKGROUND OF THE INVENTION

Integrated Sensing and Communications (ISAC) is a key area for future telecommunications. In ISAC, one aim is to enable both sensing and communications as far as possible by using the same spectrum resources. Towards this, ISAC-specific waveforms need to be designed to optimize for both use cases. Some of these may involve transmission of chirps (i.e., signals in which the frequency varies monotonically with time) for radar-like sensing, as described e.g. in Fan Liu et al.: “Integrated Sensing and Communications: Towards Dual-functional Wireless Networks for 6G and Beyond”, arXiv:2108.07165v1 [eess.SP] 16 Aug. 2021).

Repeating sequences of chirps (chirp sequences) can be used for many radar applications. However, Doppler ambiguities are an undesirable feature of such waveforms, caused by aliasing of Doppler-shifted returns where the Doppler shift exceeds the maximum shift measurable by the repetition rate of the chirps.

Furthermore, backscatter communications, in which low-capability devices (“tags”) modulate an incoming radio signal in order to add data to the re-radiated signal, can be used for near-field applications, but is also beginning to emerge for longer-range and cellular applications. The modulation may be several modes, but often a frequency modulation technique like e.g. frequency shift keying (FSK) is used by the tags.

In general, it is desirable that spectral resources be used efficiently, meaning that transmitting single waveforms which can perform multiple tasks (such as ISAC) is preferable to multiple task-specific transmissions. Such co-design, however, can be problematic. Specifically, a chirp sequence (sensing signal) waveform optimized for backscatter communications may be sub-optimal for radar sensing because of the introduction of Doppler ambiguities.

As such, using known systems, a single waveform might be optimized either for backscatter communications or for radar sensing of moving targets, but not for both.

Moreover, re-usage of the same resources for both backscatter and sensing leads to an additional problem, namely, that the receiver may not be able to differentiate between (moving) passive objects and backscattering tags if the backscattering tags just create a (shifted/scaled) version of the received sensing signal.

### SUMMARY OF THE INVENTION

It is an object of the present invention to provide an improved waveform design and signaling method for both backscatter communications and radar sensing of moving targets.

This object is achieved by an apparatus as claimed in claims 1 and 7, by an access device as claimed in claim 12, by a backscatter device as claimed in claim 13, by a system as claimed in claim 14, by a method as claimed in claims 15 and 16, and by a computer program product as claimed in claim 17.

According to a first aspect related to an access device (e.g., base station (gNB) or access point), an apparatus is provided for integrated radar sensing and backscatter communication in a wireless network, the apparatus being adapted to:
transmit a wireless sensing signal;
receive a wireless return signal from the network;
classify the wireless return signal into a passive object return signal or a backscattered return signal or a backscatter-enhanced passive object return signal; and
process the return signal according to the classification result.

According to a second aspect related to a backscatter device (e.g., a backscatter tag or a mobile device (e.g., mobile terminal (UE) or IoT device)), an apparatus is provided for backscatter communication in a wireless network, the apparatus being adapted to:
receive or retrieve a configuration of a wireless sensing waveform of an integrated sensing and communication system;
determine a reception of the wireless sensing waveform based on the received or retrieved configuration; and
backscatter the received wireless sensing waveform.

According to a third aspect related to the access device (e.g., base station (gNB) or access point), a method is provided for integrated radar sensing and backscatter communication in a wireless network, the method comprising:
transmitting a wireless sensing signal;
receiving a wireless return signal from the network;
classifying the wireless return signal into a passive object return signal or a backscattered return signal or a backscatter-enhanced passive object return signal; and
processing the return signal according to the classification result.

According to a fourth aspect related to the backscatter device (e.g., a backscatter tag or a mobile device (e.g., mobile terminal (UE) or IoT device)), a method is provided for backscatter communication in a wireless network, the method comprising:
receiving or retrieving a configuration of a wireless sensing waveform of an integrated sensing and communication system;
determining a reception of the wireless sensing waveform based on the received or retrieved configuration; and
backscattering the received wireless sensing waveform.

According to a fifth aspect, an access device (e.g., base station (gNB) or access point) is provided, which comprises the apparatus of the first aspect.

According to a sixth aspect, a backscatter device (e.g., a backscatter tag or a mobile device (e.g., mobile terminal (UE) or IoT device)) is provided, which comprises an apparatus of the second aspect.

According to a seventh aspect, an integrated sensing and communication system is provided, which comprises comprising one or more access devices of the fifth aspect and one or more backscatter devices of the sixth aspect.

Finally, according to an eighth aspect, a computer program product is provided, which comprises code means for producing the steps of the method of the third or fourth aspect when run on a computer device.

Accordingly, waveforms for use in an ISAC system can be designed such that they can be used to simultaneously support backscatter communications and (radar) sensing, wherein the waveforms may contain predictable frequency shifts which are useful for removing Doppler ambiguities caused by moving objects, and/or wherein the modulation (e.g., FSK, PSK or the like) used by the backscatter tags may allow the tags to identify themselves as non-passive objects and transmit small amounts of data. Thus, the ISAC waveforms can be used for improved sensing and for modulation for tag identification.

With the proposed waveform and system design, advantages of radar waveforms containing shifted chirp carrier frequencies (e.g., for resolution of Doppler ambiguities) can be retained, while also ensuring that the same waveform remains useful for backscatter communications. By using a single waveform for both tasks, frequency and/or time resources can be optimized, e.g., within public telecommunications systems such as the 5G system, since the sensing waveform can be reused for backscatter communications.

Furthermore, integrated transceivers (e.g., base stations or other access devices) with both communication and radar sensing functions can be provided.

According to a first option which may be combined with any of the above first to eighth aspects, a wireless sensing waveform configuration may be selected (e.g., by the apparatus of the first aspect) from a codebook and transmitted with a waveform according to the selected wireless sensing waveform configuration. Thereby, available configurations can be retrieved from a common codebook to thereby synchronize used configurations and related waveform parameters in an area of interest.

According to a second option which may be combined with the first option or any of the above first to eighth aspects, chirp start and stop frequencies between one or more adjacent chirps may be modified (e.g., by the apparatus of the first aspect) according to the codebook. This provides a straight-forward way to cope with Doppler ambiguities.

According to a third option which can be combined with the first or second option or any of the above first to eighth aspects, a backscatter device may be pre-configured or configured (e.g., by the apparatus of the first aspect) based on the selected wireless sensing waveform configuration or an available wireless sensing waveform configuration. This measure allows the backscatter device to know parameters of the transmitted sensing waveform and modify its backscattered waveform according to the configuration of the transmitted sensing waveform.

According to a fourth option which can be combined with any of the first to third options or any of the above first to eighth aspects, the wireless sensing waveform configuration may be selected (e.g., by the apparatus of the first aspect) based on one of an external distance estimation technique and an information about backscatter devices and/or passive objects in a region of interest of the wireless network. Thereby, the waveform configuration can be adapted to the environmental situation within an area of interest (e.g., a network cell) to optimize sensing parameters.

According to a fifth option which can be combined with any of the first to fourth options or any of the above first to eighth aspects, the external distance estimation technique may be used (e.g., by the apparatus of the first aspect) to estimate a distance to the furthest backscatter device in the region of interest of the wireless network. Thereby, waveform parameters of the configuration can be adapted to the maximum range required to reach all available backscatter devices.

According to a sixth option which can be combined with any of the first to fifth options or any of the above first to eighth aspects, the configuration received or retrieved by the apparatus of the second aspect may include a codebook with active wireless sensing waveforms and corresponding parameters of the integrated sensing and communication system. Thereby, backscatter devices can be informed about available configurations of the ISAC system to facilitate signaling of and adaptation to selected sensing waveforms.

According to a seventh option which can be combined with any of the first to sixth options or any of the above first to eighth aspects, the reception of the wireless sensing waveform may be determined (e.g., by the apparatus of the second aspect) by means of one or more of: (i) measuring at least one parameter of the wireless sensing waveform and determining based on the measuring result whether the wireless sensing waveform corresponds to the received or retrieved configuration; and (ii) comparing an identifier encoded in the wireless sensing waveform with a corresponding information of the received or retrieved configuration. Thus, the backscatter device is enabled to determine whether a received waveform corresponds to a target configuration which shall be backscattered.

According to an eighth option which can be combined with any of the first to seventh options or any of the above first to eighth aspects, the backscattered wireless sensing waveform may be modulated (e.g., by the apparatus of the second aspect) to match a wireless sensing waveform redirected by a passive object. Thereby, the backscatter device can use a redirected waveform received from a passive device as a reference waveform for proper modulation of its backscattered waveform.

According to a ninth option which can be combined with any of the first to eighth options or any of the above first to eighth aspects, the backscattered wireless sensing waveform may be modulated (e.g., by the apparatus of the second aspect) to include a protected identifier. Thereby, the backscatter tag can be identified by demodulating the backscattered waveform without imposing a privacy risk by allowing third parties to use the identifier (e.g., for creating fake tags).

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claims 1 and 7, the access device of claim 12, the backscatter device of claim 13, the system of claim 14, the method of claims 15 and 16, and the computer program product of claim 17 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 schematically shows a summarizing architecture of a backscatter communication and radar sensing system according to various embodiments;

FIG. 2 schematically shows a process flow diagram of backscatter communication and radar sensing using the architecture of FIG. 1;

FIG. 3 schematically shows a flow diagram of a backscatter communication and radar sensing procedure according to various embodiments;

FIG. 4 schematically shows a first example of a chirp sequence codebook showing adjacent chips with a frequency shift between each symbol according to an embodiment;

FIG. 5 schematically shows a second example of a chirp sequence codebook showing adjacent chips with a frequency shift interspersed within each symbol according to an embodiment;

FIG. 6 schematically shows an example of a chirp sequence in an OFDM-based wireless sensing signal; and

FIG. 7 schematically shows an example of a chirp sequence with a frequency shift for an OFDM-based wireless sensing signal.

### DETAILED DESCRIPTION OF EMBODIMENTS

Embodiments of the present invention are described based on a 5G cellular network environment.

Throughout the present disclosure, the abbreviation “gNB” (5G terminology) or “BS” (base station) is intended to mean an access device/point such as a cellular base station or a WiFi or Ultra-Wideband (UWB) access point. The gNB may consist of a centralized control plane unit (gNB-CU-CP), multiple centralized user plane units (gNB-CU-UPs) and/or multiple distributed units (gNB-DUs). The gNB is part of a radio access network (RAN), which provides an interface to functions in the core network (CN). The RAN is part of a wireless communication network. It implements a radio access technology (RAT). Conceptually, it resides between a communication device such as a mobile phone, a computer, or any remotely controlled machine and provides connection with its CN. The CN is the communication network's core part, which offers numerous services to customers who are interconnected via the RAN. More specifically, it directs communication streams over the communication network and possibly other networks.

Furthermore, the terms “base station” (BS) and “network” are often used as synonyms in this disclosure. This means for example that when it is written that the “network” performs a certain operation it may be performed by a CN function of a cellular network, or by a specific base station that is part of such cellular network, and vice versa. It can also mean that part of the functionality is performed by the cellular network and part of the functionality by the base station.

It is noted that throughout the present disclosure only those blocks, components and/or devices that are relevant for the proposed data distribution function are shown in the accompanying drawings. Other blocks have been omitted for reasons of brevity. Furthermore, blocks designated by same reference numbers are intended to have the same or at least a similar function, so that their function is not described again later.

The following embodiments allow for using a single waveform for both radar sensing and backscatter communication, while frequency and time resources can be optimized (especially within public telecommunications systems such as the 5G system) by re-using a sensing waveform for backscatter communications. This can be resolved, without adding to hardware complexity, by design of a waveform with alternating frequency shifts between adjacent chirps, allowing ambiguous Doppler targets to be resolved since their Doppler changes with the change in chirp carrier frequency. Examples of applicable waveforms have been described for radar sensing of moving passive targets (such as vehicles) in Wei Wang et al.: “Multi-Target Detection Method Based on Variable Carrier Frequency Chirp Sequence”, Sensors 2018, 18(10), 3386; https://doi.org/10.3390/s18103386.

Furthermore, a suitable ISAC OFDM-based diagonal waveform structure and corresponding signal processing algorithm have been described in Yi Geng et al.: “A Novel Waveform Design for OFDM-Based Joint Sensing and Communication System”, arXiv: 2301.03347v1 [cs.IT] 9 Jan. 2023. This approach allocates the sensing signals along the diagonal of the time-frequency resource block. Therefore, the sensing signals in a linear structure span both the frequency and time domains. The range and velocity of an object can be estimated simultaneously by applying 1D-discrete Fourier transform (DFT) to the diagonal sensing signals. Although this sensing signal is not a chirp, such a sensing signal and others, may also be applicable to the scenarios described in the following embodiments. In fact, the OFDM-based diagonal waveform could be considered as a discrete version of a chirp signal.

Kang Min Bae et al.: “OmniScatter: extreme sensitivity mmWave backscattering using commodity FMCW radar”, MobiSys '22: Proceedings of the 20th Annual International Conference on Mobile Systems, Applications and Services, June 2022, pages 316-329, showed that backscatter communications in the mmWave band can be greatly enhanced by transmitting symbols each comprising a sequence of n chirps at specific modulation frequencies (e.g., FSK) at backscatter tags to enable the receiver to disentangle them from clutter. The system achieved impressive results (−115 dBm sensitivity level and simultaneous communications with thousands of backscatter tags). However, this system requires a dedicated frequency-modulated continuous wave (FMCW) radar transceiver with a hardware that may not be widely available.

Conventional systems to resolve Doppler ambiguity use two intertwined chirp sequences at different carrier frequencies, which is potentially incompatible with the waveform used for known backscatter communications systems.

It is proposed to enable (wide area) backscatter communications on top of an existing ISAC waveform, without introducing Doppler ambiguities, by modifying the chirp start and stop frequencies between adjacent (or at least, symbols of n) chirps according to a codebook. Backscatter tags can then still reliably be identified, e.g., by performing data/signal modulations, e.g., or by knowing a codebook and having the tags locally compensate for the known frequency offset of each transmitted chirp, while radar sensing services can also resolve Doppler ambiguities, even when using the same waveform. The frequency offsets between the different chirps to be used in the waveform can be designed based on the range of operating frequencies which are feasible for standards-compliant backscatter tags and which are compatible with e.g. the high definition (HD) FMCW approach or alternative wireless signal designs.

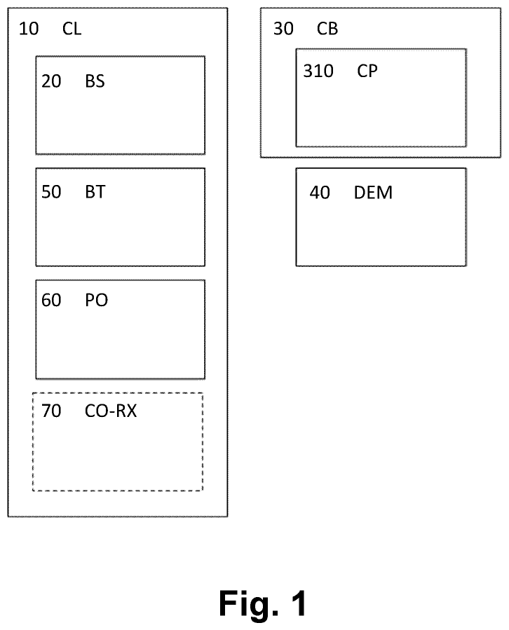

FIG. 1 schematically shows a summarizing architecture of a backscatter communication and sensing system according to various embodiments.

The components shown in FIG. 1 may be jointly located within a “cell” (CL) 10, which is to be understood as an area of coverage provided by an access point (e.g., base station) in a cellular network or other communications system.

A base station (BS) 20 (such as a gNB of a 5G network) provides a central access point for devices in the cell 10. The base station has a radio interface plus access to a core network (CN). As indicated above, the base station 20 may be a managing entity centralized (e.g., at the cell 10) or distributed (e.g., gNB-CU running in a cloud and gNB-DU).

Furthermore, one or more “backscatter tags” (BT) 50 may be provided, which are to be understood as devices that participate in backscatter communications over the radio interface, with either the base station 10 or other nearby devices acting as receivers for backscattered signals. The backscatter tags 10 contain (at least) suitable radio hardware to backscatter received radio signals. They may do so with additional modulations representing data and/or additional modulations (e.g., frequency shift (FSK) or PSK based, etc.) for the present system. As an example, the tags described in the above-mentioned Kang Min Bae et al.: “OmniScatter: extreme sensitivity mmWave backscattering using commodity FMCW radar”, MobiSys '22: Proceedings of the 20th Annual International Conference on Mobile Systems, Applications and Services, June 2022, pages 316-329, would be a suitable example.

Furthermore, the backscatter tags 50 may have a data connection mode which is not backscatter-based. E.g., they are able to act as terminal devices (e.g., UEs) in the network to receive data via conventional means or may have another wireless interface such as Bluetooth, NFC, optical, etc., or may support a wired interface such as I2C.

Additionally, passive objects (PO) 60 may be provided, which are to be understood as objects within the cell 10 which do not necessarily communicate with the base station 20 but for which some features such as, e.g., the location or velocity, should be determined via wireless sensing—for example, cars, trucks, and other moving or non-moving objects.

Optionally, cooperative receivers (CO-RX) 70 may be provided (e.g., UEs, other gNBs or separate transmit/receive points of the base station 20), which are to be understood as communications devices within the cell 10, which are configured to assist in wireless sensing of passive objects or assist the backscatter communications process by receiving signals from the base station 20 and/or backscattered returns from the backscatter tags 50 and/or the passive objects 60 and forwarding them or processed results thereof to the base station 20.

Furthermore, the architecture comprises a codebook (CB) 30 containing sensing signal parameters (CP) 310 such as “chirp parameters”, which is accessible to at least the base station 20 and the backscatter tags 50 and/or the cooperative receivers 70. The codebook 30 may be stored in a memory on those devices or may be accessed via the CN. The sensing signal parameters 310 may include one or more of a frequency and timing behavior of the sensing signal (e.g., initial frequency, end frequency, time span) and a modulation to be applied to the sensing signal by the backscatter tag 50 (e.g., compensation (e.g., removal) of frequency shift fs between symbols) so that the cooperative receivers 70 and/or the base station 20 can differentiate between the backscatter tags 50 and the passive objects 60. In an example, the receiver may mix incoming reflections with the outgoing chirp.

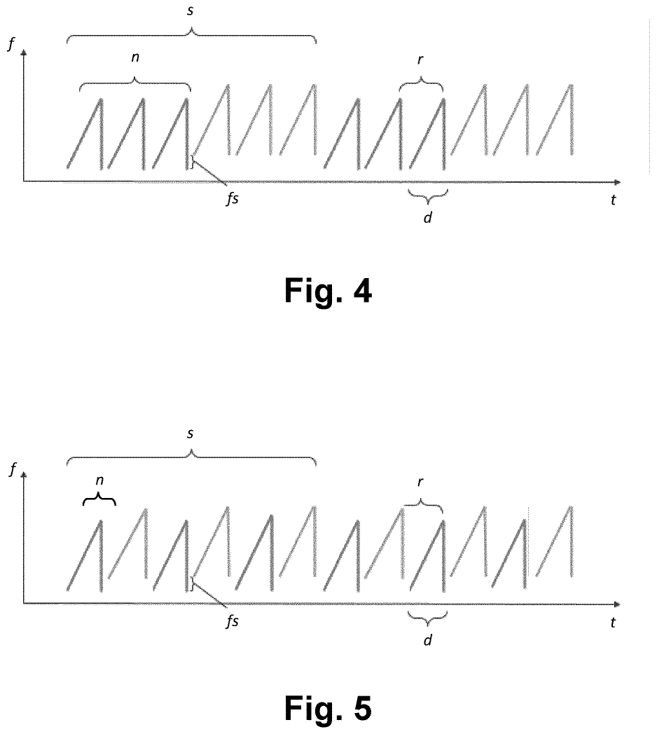

The frequency and timing behavior parameters may comprise one or more of a sensing signal (e.g., chirp) carrier frequency, a sensing signal (e.g., chirp) frequency span, a frequency shift fs between symbols (example shown in FIG. 4) or within a symbol (example shown in FIG. 5), a number n of sensing signals (e.g., chirp) per symbol, a sensing signal repetition rate r within a symbol, a sensing signal duration d, and a symbol repetition rate s.

Additionally, the architecture of FIG. 1 comprises a demodulation function (DEM) 40, which may be implemented as a software/hardware module that can be run by the base station 20 or accessed remotely (e.g., as a network function). The demodulation function 40 may be configured to accept as input the returns received from the backscatter tags 50 and the passive objects 60 optionally mixed with the sensing signal (e.g., chirp signal) used to “illuminate” the backscatter tags 50, plus the employed sensing signal parameters 310 (e.g., chirp Parameters), and both demodulates the data from the backscatter tags 50 and determines information related to the backscatter tags 50 and/or the passive objects 60.

In embodiments, a simple form of codebook may include two different chirp start/stop frequencies which alternate, but others can also be used, including those with symbols consisting of groups of n chirps larger than two, more than two frequency levels or even pseudo-random modulation.

In other embodiments, another simple form of codebook may include two different start/stop frequencies which alternate in an OFDM-based diagonal sensing signal.

It is beneficial if the modulation applied to the transmitted waveform is known to the backscatter tags so that they can adjust their response to it and to the radar receiver such that it can perform correct range and Doppler calculations. If the return data/signal is modulated, multiple modulations may be applicable, e.g., it may be FSK, but it may also be, e.g., PSK, etc. The advantage is that the receiver can distinguish between backscatter tags and passive objects as long as the receiver knows how a tag is modulating the backscattered signal/data and this modulation is different than the sensing signal reflected on passive objects.

In an example, a basic, unmodulated chirp signal has a carrier with frequency f0 representing the start frequency. It climbs a shift of Fs (signal shift) in time Ts (chirp interval, i.e., the duration between the start of successive chirps) and repeats at a repetition rate r, where

r=1/Ts.

Practical constraints may limit the duration d of the chirp to a value d≤Ts with an inter-chirp dwell period of Ts−d at the end of the chirp, during which no RF energy is transmitted, and a maximum practical frequency shift of Fd≤Fs. For simplicity in description, it is assumed that d=Ts and Fd=Fs. Thus, the instantaneous chirp frequency f at time t can be written as:

$$f = f 0 + Fs * tc / Ts \qquad ( 1 )$$

where tc=t mod Ts, where the mod function limits the range of tc to 0≤tc<Ts, thereby providing the sawtooth function.

In a variant of the example, FIG. 5 shows successive chirps switching between a carrier of f0 and f0+fs, where F_offset is a frequency offset applied to assist with Doppler disambiguation. Chirps are shifted in frequency but are otherwise unchanged so the instantaneous chirp frequency of equation (1) can now be written as:

$$f = f 0 + Fs * tc / Ts + i * F\_offset \qquad ( 2 )$$

where i is a switch, applied over the chirp interval and defined as:

$$i = floor \{ t / Ts \} mod 2$$

where the floor function reduces the quotient t/Ts down to the nearest integer and the mod function reduces the result to values 0 and 1.

In an additional variant of the example, based on Kang Min Bae et al.: “OmniScatter: extreme sensitivity mmWave backscattering using commodity FMCW radar”, MobiSys '22: Proceedings of the 20th Annual International Conference on Mobile Systems, Applications and Services, June 2022, pages 316-329 and depicted in FIG. 4, chirps are grouped into symbols comprising n chirps, with symbol repetition rate s expressed as:

$$s = 1 / T\_sym$$

where T_sym is the symbol interval, i.e., the duration between the start of successive symbols, and with symbol duration, d_sym expressed as

$$d\_sym = n * Ts$$

where, dsym≤T_sym and, if d_sym<T_sym, there is an inter-symbol dwell period of T_sym−d_sym at the end of the symbol during which no RF energy is transmitted. Again, for convenience, we assume that T_sym=d_sym, allowing us to express s in terms of r as:

$$s = r / n$$

and T_sym in terms of Ts as:

$$T\_sym = n * Ts$$

Although the chirps are nominally grouped into symbols, with no inter-symbol dwell period, they would appear as a continuous stream when transmitted. This may be advantageous when a co-operative receiver is used because symbol synchronization between transmitter and receiver may not be required.

FIG. 4 also shows a further variant in which successive symbols are offset by F_offset. The instantaneous chirp frequency can be given as:

$$f = f 0 + Fs * tc / Ts + i\_sym * F\_offset \qquad ( 3 )$$

where i_sym is a switch, applied over the symbol period and defined as:

$$i\_sym = floor ( t / T\_sym ) mod 2$$

FIG. 5 additionally a yet further variant in which symbols can be formed from a sequence of chirps with alternating offsets, i.e., symbols can be formed comprising chirps in which F_offset is applied to chirps within the symbol. If symbols comprise an even number of chirps then the instantaneous chirp frequency is given by equation (2) above. If the symbols comprise an odd number of chirps then successive symbols will invert the frequency offsets (i.e., even-numbered symbols may start with f0, odd-numbered symbols, fo+F_offset). Alternatively, if symbols remain identical, then, at the boundary between two symbols, there will be two successive chirps with the same carrier frequency. This could be used as the basis of a symbol synchronisation method. The instantaneous chirp frequency can be written as:

$$f = f 0 + Fs * tc / Ts + i\_comb * F\_offset \qquad ( 4 )$$

where i_comb is a combination switch, applied over both the chirp period and the symbol period, and defined as:

$$i\_comb = ( floor ( t / Ts ) + floor ( t / T\_sym ) ) mod 2$$

A tag receiving a chirp signal of instantaneous frequency f, given by any of the equations (1) to (4), can modulate the return signal f_ret. In an example, this may be done using frequency shift keying (FSK) according to:

$$f\_ret = f + f\_tag ,$$

where f_tag is, in this example, an FSK signal centred around a carrier frequency fm, modulated according to:

$$f\_tag = fm + f d . a ( t )$$

where fd is the peak shift of the carrier frequency fm and a(t) is a modulating signal derived from a binary sequence using the symbols {+1, −1}, which is optionally low-pass filtered to shape the spectrum of f_tag as needed.

Alternatively or additionally, the tag may also be instructed to perform other functions like (partially) compensating for F_offset or otherwise modifying the reflected signal in a way that enables it to be disambiguated from moving passive objects.

At the receiver, the incoming f_ret is mixed with the outgoing f (for collocated transmitter/receiver operation), a locally derived f that is optionally arranged to be synchronous with the transmitter or a locally-received f derived from the transmitter (for co-operative receiver operation).

For collocated and synchronised non-collocated operation, we have:

$$f\_mix = f ( t ) * f\_ret ( t , τ ) = f ( t ) * ( f ( t - τ ) + f m + f d . a ( t - τ r ) )$$

where τ is the total time from transmitter to tag and the return to the receiver and tr is the trip time from tag to the receiver and the symbol ‘*’ demotes a non-linear mixing operation whose output comprises sum and difference frequencies of the input signals.

The outgoing chirp f(t) and the delayed return f(t−τ) mix to produce f_diff(τ), a frequency that depends on the slope of the chirp and the delay t. This can be used to estimate the distance of the tag from the transmitter/receiver. The frequency f_diff is modulated by f_tag.

Advantageously, the mixer may be arranged to produce only the lower side band at its output, i.e., frequencies from f_ret that are lower than f(t). This prevents long-delayed returns from the previous chirp from mixing with the current chirp and producing false readings. Optionally, the signals from the upper side band could also be used to allow analysis of said long-delayed returns

Advantageously, the outgoing chirp is modulated with a signal that may comprise elements that can be used as a time stamp. Advantageously, this signal is orthogonal to the modulation imposed by the tag. In one embodiment, the receiver mixes the incoming return with a ‘clean’, unmodulated version of the chirp so that only the returned time stamp modulation remains on f_diff. This can be compared with the outgoing chirp to get an estimate of the round-trip time. In another embodiment, suitable when no clean chirp is available, the returned time stamp modulation is mixed with the outgoing time stamp modulation to produce a third signal that can be used to determine transit time. A possible candidate signal could be a maximum length sequence, which, in general, have the property that the modulo-2 sum of a sequence and a time-delayed sequence produces a third phase of the same sequence. By comparing the phase of the third sequence with that of the outgoing chirp, an estimate of the round-trip time can be made.

Advantageously, if the tag is known to be synchronized with the transmitter (e.g., it is connected to a UE that is synchronized with the network), the signal from the tag to the receiver can comprise information that can be used to estimate the length of the path from tag to the receiver.

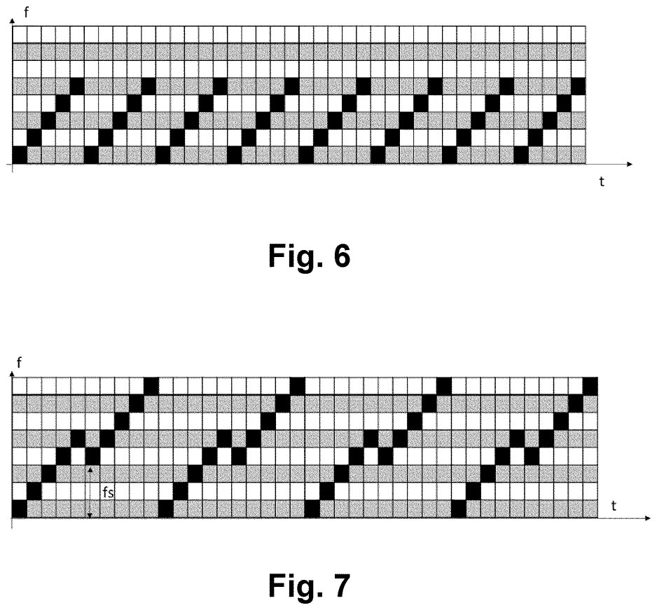

FIG. 6 schematically shows an example of a chirp sequence in an OFDM-based wireless sensing signal, wherein the vertical direction of the grid indicates subcarrier numbers and the horizontal direction of the grid indicates symbols. In this example, the OFDM-based wireless sensing signal is FSK-modulated by a backscatter tag to derive/backscatter a chirp signal as follows:

A carrier fci with frequency f0+fdelta*i is active at time ti, where i may be t/T mod Ts and where f0 is a baseline frequency, fdelta is the frequency separation between carriers, T is the time during which a carrier is used, and Ts is the period of the signal. Thus, the frequency f(t) at time t of the OFDM-based wireless sensing signal is:

$$f ( t ) = f 0 + fdelta * ( t / T ( mod Ts ) )$$

Then, a backscatter tag may apply an FSK modulation on the signal to derive a chirp signal by FSK modulating the backscattered wireless sensing signal with a carrier of frequency fₘ:

fm=(fdelta/T)*(t−int(t/T))
where fs is the slope of the chirp that equals fdelta/T and int (a) is a function that returns the integer part of a. This gives an example of how an access device (e.g., gNB) may use a wireless sensing signal to sense passive objects that may be reused by backscattering tags.

In this example, the backscatter tag needs to synchronize to the received OFDM-based signal, namely, to monitor when the steps of the received signal happen so that the signal can be properly modulated

This allows reusing a wireless sensing signal as in Yi Geng et al.: “A Novel Waveform Design for OFDM-Based Joint Sensing and Communication System”, arXiv: 2301.03347v1 [cs.IT] 9 Jan. 2023, for backscattering communication as in Kang Min Bae et al.: “OmniScatter: extreme sensitivity mmWave backscattering using commodity FMCW radar”, MobiSys '22: Proceedings of the 20th Annual International Conference on Mobile Systems, Applications and Services, June 2022, pages 316-329.

In a further example, the OFDM-based wireless sensing signal may also benefit from the proposed techniques.

FIG. 7 schematically shows such an example of a chirp sequence with a frequency shift for an OFDM-based wireless sensing signal. Here, the OFDM-based wireless sensing signal shown in FIG. 6 is converted by applying a frequency shift fs to alternating wireless sensing signals in a similar manner as described for chirps and illustrated by means of FIG. 5.

In the following embodiments, wireless sensing signals (such as chirp sequence waveforms) are designed with variable parameters (including, among others, a frequency shift fs applied to the wireless signal's (chirp's) start frequency (the “chirp carrier frequency”) between chirps or groups of chirps. Available parameters (described later) for generating corresponding waveforms of different properties are stored in a codebook.

A transceiver device (e.g., the base station 20 of FIG. 1) selects an appropriate waveform based on the available codebook parameters of the codebook (e.g., the codebook 30 of FIG. 1) in accordance with its intended usage scenario and/or the parameters of the backscatter tags (e.g., the backscatter tags 50 of FIG. 1) and/or sensing being addressed. It then uses the retrieved parameters to generate and transmit sensing signals (e.g., chirp sequences) representing the desired waveform.

Optionally, the transceiver device may inform backscatter tags of its parameter selection from the codebook or the backscatter tags may be pre-configured. In the latter case, the transceiver device may be constrained by the pre-configuration of the backscatter tags.

The backscatter tags may be configured to modulate the received/backscattered signal in a pre-agreed way. The codebook may also indicate how backscatter tags are required to modulate the backscattered signal so that the transceiver device may differentiate between backscatter tags and passive objects. In some use cases, the backscatter tags may compensate for the frequency shift (e.g., by applying an equal and opposite frequency shift, in addition to their normal modulations).

The transceiver device receives returns (backscattered signals) from tags and/or passive objects (e.g., the passive objects 60 of FIG. 1). Alternatively, a co-operative mobile terminal, such as a user equipment (UE) in 5G terminology, (e.g., the cooperative receiver 70 of FIG. 1) may receive the returns from the tags and/or passive objects, e.g., in a distributed sensing setting.

Demodulation (e.g., by the demodulation function 40 of FIG. 1) of received returns may be performed by mixing received signals (returns) with the transmitted original waveform (e.g., chirp) to check whether the received signals are modulated by a backscatter tag or not (passive object) so that the transceiver device can differentiate between tags and passive objects. For instance, this may involve removing the additionally applied frequency shift fs from the received returns and mixing the returns with the original (outgoing) waveform, or in the case of a co-operative UE, mixing the received returns with the received and forwarded copy of the original waveform or a self-generated waveform that may be synchronized to the transceiver device's original waveform, classifying the received returns into modulated or not, and processing the received returns according to their classification.

For instance, the tag may be instructed to FSK-modulate the wireless signal in a time-wise manner. For instance, the modulating frequency is fm*square_wave(T1, T2, t) where square_wave is a square wave that may take value 0 or 1. It takes value 0, if t mod (T1+T2) is less than T1 and 1 otherwise.

When the receiver receives the backscattered signal from a tag, it can determine that the backscattered signal is modulated with a square wave and retrieve the frequency fm from it.

The transceiver device may decode tag data received from backscatter tags or calculate the range and Doppler shift of passive objects, so that the transmitted waveform is used for both passive IoT by backscatter tags and sensing.

For instance, the transceiver device may determine the spectrum of each received sensing signal (e.g., chirp) e.g., via Fast Fourier transform (FFT), and, via further processing, if the sensing signal has been received from a backscatter tag or a passive object.

If the sensing signal has been received from a backscatter tag, the transceiver device may perform at least one of identifying the tag based on its modulation frequency, determining the distance or range of the tag based on the channel, decodes tag data transmissions, and determining the Doppler shift due to motion of moving tags by using the frequency shift fs applied to the chirp carrier frequencies.

If the sensing signal has been received from a passive object, the transceiver device may use the received signal to determine, e.g., location and/or speed.

Examples of possible more detailed strategies could be:
Per chirp symbol: apply FFT, estimate range (according to frequency bin), and demodulate tag data.
Per chirp symbol pair: apply FFT, estimate range (according to frequency bin), apply FFT across range bins from successive odd chirps and even chirps, estimate aliased velocity separately for odd and even chirps, and use odd and even results to ‘de-alias’ velocity according to applied frequency shift.

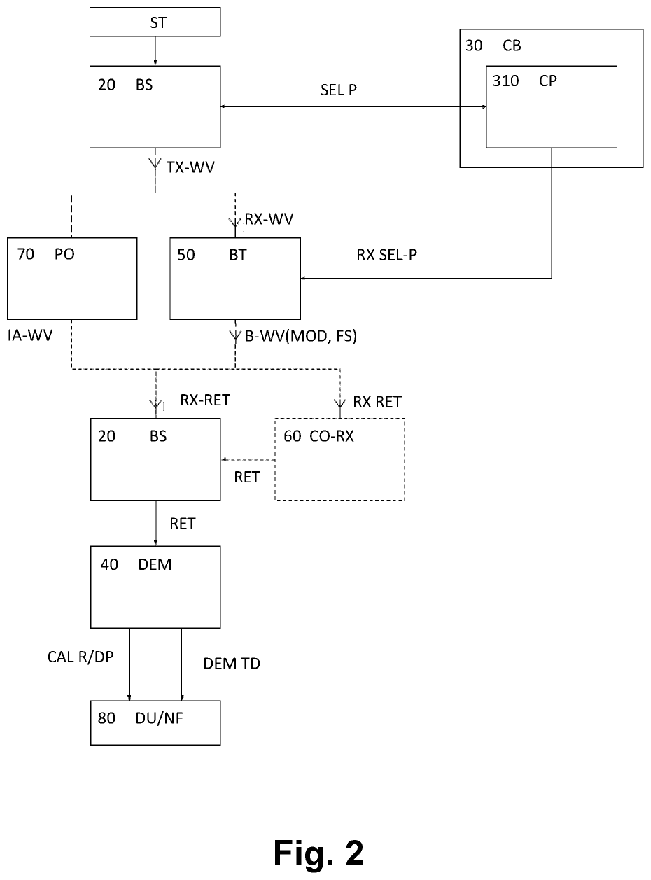

FIG. 2 schematically shows a process flow diagram of backscatter communication and radar sensing using the architecture of FIG. 1.

After start (ST) of the process, the base station 20 accesses the codebook 30 (e.g., via the CN of the wireless communication system (e.g., 5G system)) and selects codebook parameters 310 (SEL P). Then, the base station 20 generates a corresponding waveform (TX-WV) and transmits or broadcasts a sensing signal with the generated waveform towards passive object(s) 70 and/or backscatter tag(s) 50. The waveform may be received (RX-WV) by the passive objects 70 and/or the backscatter tags 50.

Meanwhile, the backscatter tags 50 (which may be UEs) have received or retrieved the selected codebook parameters (RX SEL-P) (e.g., via the data plane of the wireless network). Thus, when they receive the waveform from the base station 20, they backscatter a waveform (B-WV (MOD, FS)) with modulated data and a frequency shift fs as defined by the selected codebook parameters. By contrast, the passive objects 70 merely interact (reflection and/or deflection (refraction)) with the waveform received from the base station 20 in a passive manner and return an interaction waveform (IA-WV).

The waveforms (returns) returned from the passive objects 70 and/or the backscatter tags 50 are received (RX-RET) by the base station 20 and optionally by cooperative receivers 60 (e.g., UEs or gNBs) which forward the returns (RET) to the base station 20.

The base station 20 then forwards the returns (RET) to the integrated or remote demodulation function 40 which calculates (CAL R/DP) a range and Doppler shift for sensing signal and/or demodulates (DEM TD) the tag data received from the backscatter tags. The obtained information (range, Doppler shift and/or tag data) is then forwarded to a downstream user or network function (DU/NF) 80 for further processing according to an underlying application which demanded backscatter communication and/or radar sensing.

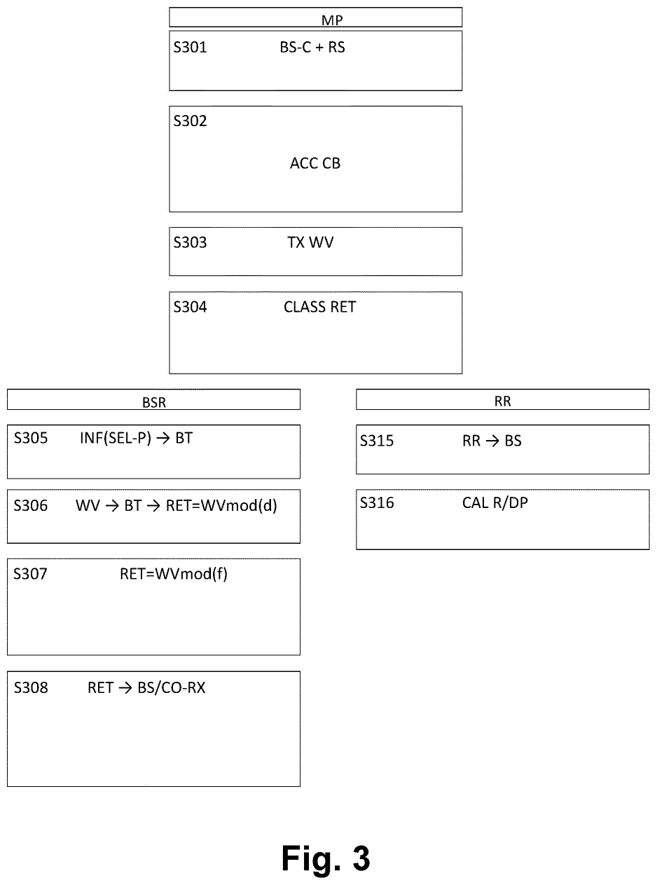

FIG. 3 schematically shows a flow diagram of a backscatter communication and radar sensing procedure according to various embodiments.

In step S301 of an initial main process (MP), a base station performs both radar sensing (RS) of passive objects and backscatter communications (BS-C) with a number of backscatter tags within its cell.

In step S302, the base station accesses a codebook (ACC CB) to generate a suitable waveform consisting of chirp sequences with frequency shifts. The chirp parameters (including frequency shifts, number of chirps per symbol, chirp repetition rate, and other parameters) are selected by the base station from the codebook according to e.g. its usage scenario.

In step S0303, the base station generates and transmits a waveform (TX WV) generated according to the selected parameters.

In step S304, the base station receives return signals from the network. It classifies them as radar returns or backscatter returns according to whether the frequency and apparent Doppler shifts change by the selected predetermined frequency shift fs between adjacent chirps. If yes, the procedure branches to a radar return procedure (RR) comprising steps S315 and S316. If no, the procedure branches to a backscatter return procedure (BSR) comprising steps S305 to S308.

In step S305 of the backscatter return procedure, the backscatter tags receive or retrieve information (INF (SEL-P) about the codebook parameters selected by the base station (e.g., forwarded via a data plane connection or set by a network policy function).

In step S306, the backscatter tags receive the waveform (WV) transmitted by the base station and backscatter (return) the waveform (RET=WV mod(d)) with additional modulated data to be transmitted.

In addition to the modulations representing their data, the backscatter tags further modify in step S307 the frequency of the backscattered waveform (RET=WV mod(f)) using knowledge of the selected codebook parameters. For example, they might attempt to apply the opposite shift in frequency from the frequency shift fs applied by the base station, thus compensating it.

Thanks to the modified backscatter frequency, the signals originating from backscatter tags can be easily distinguished from clutter (because they are frequency-shifted), and from moving objects (because their apparent Doppler frequency shift does not change between different chirps) either directly by the base station or by a nearby co-operative backscatter receiver or helper UE.

Finally, in step S308, the base station and/or co-operative UE(s) receive the backscattered returns (RET). The returns are demodulated by the base station while compensating for the additional frequency shift fs applied by the backscatter tags, to decode the data transmitted.

In the alternative case of the radar return procedure, the base station receives in step S315 radar returns of the waveform from the passive objects and compensates in step S316 the frequency shift fs applied as part of the codebook to calculate the true range and Doppler shift of the passive object.

In embodiments, the waveform of the sensing signal may be designed in a one-off or infrequent process and resulting wireless sensing signal (e.g., chirp) parameters are stored in the codebook. The codebook may form part of a communications standard (such as a telecommunication standard) and may be updated along with other updates to that standard to reflect changes e.g. to the hardware of devices such as backscatter tags and/or type(s) of passive objects that are to be detected/sensed.

In embodiments, the chirps may be ‘true’ chirps, that is, signal modulations in which the frequency increases linearly with time for a given duration d across a given bandwidth (frequency range) between start and stop frequencies. Other forms of wireless sensing waves may be applicable with appropriate adaptations to the processing of return signals. These other forms may include ‘pseudo’ chirps, ‘stepped’ chirps, chirps with linear or non-linear slopes, and chirps with other shapes, e.g., down-sloping chirps, triangular chirps, sine-wave chirps.

‘Pseudo’ chirps are signals created to approximate true chirps as closely as possible within the constraints of existing transmission hardware or an existing modulation scheme (e.g., compatible with existing OFDM hardware). An example is the creation of a good approximation to chirps within DFT-s-OFDM modulation by small filter design changes (cf. Alphan Sahin et al.: “DFT-spread-OFDM Based Chirp Transmission”, arXiv: 2008.03766v2 [eess.SP] 21 Nov. 2020).

‘Stepped’ chirps are signals consisting of several sub-chirps, each covering part of an overall bandwidth. The stepped chirp waveform is a concept for increasing the range resolution of an existing pulse compression radar. This technique is suited to obtaining high range resolution in a radar system that has a limited instantaneous bandwidth but a large tunable bandwidth. This is the case when a number of radar sets of the same type have to share a frequency band with each other so that mutual interferences are minimized. In pulse compression radar, the transmitted bandwidth is a measure of the range resolution. Range resolution in radar is inversely proportional to the transmitted signal bandwidth. The stepped chirp waveform splits the full bandwidth linear frequency modulated (LFM) chirp into a sequence of narrow-band sub-chirps, which may overlap in frequency. However, if the frequency band of the transmitted signal is skipped within sub-pulses in the tunable bandwidth and the received echo signals are properly combined to the carrier frequencies, the composite signal has effectively increased bandwidth and hence improvement in range resolution can be achieved. As the receiver is then only tuned to the narrow-band sub-chirp it offers high rejection to other radars transmitting at other sub-bands. The radar transmits and receives on one frequency at a time. It then adjusts both transmitter and receiver to operate at the next frequency and transmits the next sub-chirp, and so on. The sub-chirps needn't be transmitted in order (i.e., Costas Code waveform) but this adds to the complexity of processing. However, in this case, each sub-chirp could be transmitted opportunistically when its sub-band is free. Practically, an existing pulse radar such as the ASR-E could use the stepped chirp waveform and can thus take the advantages of the improved range resolution only by software changing.

Where stepped chirps are used, all sub-chirps should be transmitted before beginning the next stepped chirp, to avoid frequency ambiguities.

In case of using chirps with non-linear slopes, the steeper the slope, the greater the frequency resolution. Thus, chirps may be designed to take advantage of this. For example, a rising chirp with increasing slope provides extra resolution at greater distances, potentially compensating for timing uncertainties rising with distance. Thus, an operator wanting to study a region more closely may use a chirp with a steeper slope in the region of interest.

In embodiments, chirps may be configured to carry data. This may be achieved by modulating the chirps directly in, e.g., frequency/phase and/or amplitude. The modulating signal may be pre-processed to facilitate demodulation. For example, the frequency/phase modulation may be impressed such that differentiating the incoming signal results in frequency/phase modulation on a steady carrier.

As another option, chirp trains may carry modulation in the chirp parameters, such as at least one of the start (or carrier) frequency, the stop frequency, the chirp duration, the chirp slope, and the chirp shape.

In some examples, the chirps may have the “start frequency” (also referred to as “chirp carrier frequency”) and “stop frequency” as parameter. These may be selected based on the available spectrum within the network cell. E.g., the “bandwidth” (i.e., stop frequency minus start frequency) may be selected based on the available spectrum within the network cell. Optionally, the bandwidth parameter may be varied iteratively by the base station using the codebook, to minimize the overall use of spectrum while meeting its sensing and backscatter goals.

For example, the base station may initially select chirps of a smaller bandwidth. If these are found to be insufficient for the current situation (i.e., do not support enough concurrent backscatter tags and/or resolution of radar sensing is not high enough), the base station may increase the bandwidth to a higher bandwidth, and so on.

In embodiments, the frequency shift fs may be designed based on comparing the following two competing requirements:
(1) In all cases, the frequency shift fs should be large enough that Doppler shifted returns from the same moving target are different when illuminated by chirps shifted by fs, up to the maximum desired velocity to be measured by the radar system. The precise value of the frequency shift fs which satisfies this requirement will depend on the chirp carrier frequency used and the desired maximum unambiguous velocity. As an example for a chirp carrier frequency of 24 GHZ, a frequency shift fs of 0.15 GHz supports measurement of unambiguous velocities up to 50 m/s.
(2) In combination with the above, the frequency shift fs should be small compared with the chirp carrier frequency and bandwidth, to avoid significant changes in the carrier frequency and associated propagation properties between shifted chirps. As an example, the frequency should be less than 1% of the chirp carrier frequency and bandwidth.

Additionally, the frequency shift fs should be small enough that all chirps after shifting are within the operating frequency range of the backscatter tags.

Waveforms with several values of frequency shift fs may be designed and may be selected by the base station based on its known or predicted usage scenario (i.e., desired maximum unambiguous passive object velocity and design of backscatter tags in use).

As a further parameter, the number n of chirps per symbol may be selected based on a trade-off between backscatter and radar sensing.

A higher number n is preferable for backscatter, because it allows for more backscatter tags per channel if distance-based channels are used, as discussed in Kang Min Bae et al.: “OmniScatter: extreme sensitivity mmWave backscattering using commodity FMCW radar”, MobiSys '22: Proceedings of the 20th Annual International Conference on Mobile Systems, Applications and Services, June 2022, pages 316-329.

A lower number n is preferred for radar sensing (e.g., n=1) because the chirp carrier frequency changes more often, which allows shifted samples to be collected more quickly for resolution of Doppler ambiguities, as discussed in Wei Wang et al.: “Multi-Target Detection Method Based on Variable Carrier Frequency Chirp Sequence”, Sensors 2018, 18(10), 3386; https://doi.org/10.3390/s18103386.

In embodiments, waveforms with several values of the number n may be designed and selected from by the base station depending on the primary goal. If the primary goal is radar sensing (and especially, if there are fast-moving passive objects to be sensed), then a lower number n will be preferred. If the primary goal is backscatter communications, then a higher number n will be preferred. If a mixture of both should be supported, the base station may select an intermediate value of n, which may be the minimum number n required to support a required number of backscatter tags per channel. This minimum number n can be estimated by comparing the known cell size with a known or estimated number of backscatter tags which are active.

In embodiments where the frequency shift fs between chirps occurs within a symbol (example shown in FIG. 5), Doppler disambiguation is facilitated within each symbol. This might alternatively or additionally be used to design stepped chirps, as discussed above.

Further parameters which may be considered are the chirp repetition rate r within a symbol and the chirp duration d.

To transmit a desired number n of chirps per symbol in the minimum possible time (and therefore minimize latency), the chirp duration d should be minimized, while respecting cell coverage and/or base station hardware capabilities.

The minimum allowable chirp duration d is given by the physical size of the cell multiplied by 2/c (where c is the speed of light) to ensure that each transmitted chirp overlaps with its received echo to allow mixing at the base station for radar sensing. The base station hardware capabilities (i.e., maximum feasible chirp slope which can be generated) will also set a lower bound on the chirp duration d.

Since these parameters are cell-specific, several waveforms can be designed and selected by the base station at runtime based on the cell characteristics. The parameter chirp duration d sets a maximum for the chirp repetition rate r (where the chirps just overlap). The base station may optionally choose parameter values that leave gaps between adjacent chirps e.g. to avoid inter-chirp interference.

A still further parameter is the symbol repetition rate s. A minimum value for this parameter will arise from the number n of chirps, the chirp duration d, and the chirp repetition rate r. The base station may optionally choose the symbol repetition rate s to leave gaps between symbols for e.g., resource allocation to other tasks.

Two example waveforms suitable for different scenarios are shown in FIGS. 4 and 5.

FIG. 4 schematically shows a first example of a chirp sequence codebook showing adjacent chips with a frequency shift between each chirp symbol according to an embodiment. Thus, chirp symbols are transmitted on different chirp carrier frequencies. This allows simultaneous processing for tag identification and Doppler disambiguation.

FIG. 5 schematically shows a second example of a chirp sequence codebook showing adjacent chips with a frequency shift interspersed within each chirp symbol according to an embodiment.

In case of waveforms of FIG. 4 where the number n of chirps and the frequency shift fs are both small, the frequency shift fs may be compensated for by the backscatter tags by subtracting the frequency shift from their modulation frequency. In this case, clutter returns and true Doppler shifts from passive objects change along with the applied frequency shift fs and Doppler ambiguities can be resolved e.g. according to the technique described in Wei Wang et al.: “Multi-Target Detection Method Based on Variable Carrier Frequency Chirp Sequence”, Sensors 2018, 18(10), 3386; https://doi.org/10.3390/s18103386. Furthermore, backscatter tag signals appear like Doppler shifts, shifted by the tag's modulation frequency, but now do not change along with the applied chirp frequency shift and so can be disambiguated from moving objects. Where less than total compensation of the frequency shift fs is feasible for the backscatter tags, they may apply partial compensation operations. So long as these are correctly timed along with the receipt of shifted chirps the backscatter tags can still be disambiguated from passive objects.

For example, the backscatter tags may apply opposite compensations to adjacent shifted chirps in a way that would be unusual or impossible for a moving passive object to generate via true Doppler shift.

As another option, the backscatter tags may not compensate the frequency shift, but just modulate the received signal in a pre-defined manner. This results in fewer frequency shifts and resolves Doppler issues over longer periods, while allowing a simpler configuration of the backscatter tags.

Otherwise, in case of waveforms of FIG. 4 where the number n of chirps is large, the waveform may integrate dedicated sub-periods where no frequency shift occurs between adjacent chirps, so long as Doppler ambiguities can be resolved within a desired accuracy by use of later chirps which are frequency shifted. This provides fewer frequency shifts fs and resolves Doppler shifts over longer periods but enables a simpler backscatter tag design since the modulation frequency can be fixed (i.e., no need for compensation of the frequency shift) and backscatter returns simply ignored during the frequency-shifted period. It is however still advantageous for the backscatter tags to know the codebook and the timing of the chirp transmissions such that they can exclusively modulate their data in the un-shifted periods.

In this case, the main waveform parameters subject to optimization are the number n of adjacent chirps before the frequency shift occurs and their corresponding repetition rate r to achieve a desirable interval over which sufficient frequency shifts do occur. In embodiments, waveform selection may be performed by a centralized and/or distributed entity requiring wireless sensing/backscattering communication (e.g., a base station or (other) demodulation function). The following embodiments are described for the case that the selecting entity is a base station.

To select a suitable waveform, the base station considers its capabilities and its usage scenario.

In an embodiment, the base station may select a value of the frequency shift fs according to a (known or estimated) model of the backscatter tags in use. Furthermore, the base station may select the number of chirps n based on whether its primary goal is sensing (lower n), backscatter (higher n), or a mixture (intermediate value). Additionally, the base station may select the chirp duration d such that it is just sufficiently short to achieve the required area coverage. Optionally, as an example, the base station may use an external distance estimation technique (such as timing advance) to estimate the distance to the furthest backscatter tag and employ this for the cell size. However, a different, larger chirp duration d may be selected to increase the sensing range.

Once it has selected the waveform based on the available codebook content, the base station may inform the backscatter tags of its selection (e.g., via a data plane connection), or may include this parameter information in the wireless sensing signal itself, (e.g., it may include a dedicated pre-waveform transmission which is different to the chosen waveform and which encodes both its choice of parameters and a start time for the main waveform transmission). This allows backscatter tags which can only receive wireless sensing-like signals (i.e., no data connection) to know the codebook selection and the timing of the upcoming transmission. The timing information may have the advantage of making the backscatter tags more efficient.

In an example, the timing synchronization may be achieved via an external timing reference signal/source available to both the base station and the backscatter tags, or by inserting specific timing features within the waveform. For example, a specific waveform (e.g., chirp sequence) could be defined which can be detected by the backscatter tags and which acts as a reference point.

In embodiments, the backscatter tags may modulate the backscattered waveform to convey information. For instance, it may introduce a phase shift (e.g., used to encode data, such as an identifier associated to the tag), e.g., when the received signal has a frequency fk=f0+k*fT or in a regular manner (e.g., every T seconds) from a predefined starting time. In such embodiments, the backscatter tags may need to determine the time to start encoding information. This time may need to be aligned with certain features of the received signal, e.g., when a received chirp is at the lowest frequency f0. This time may be preconfigured or may be announced in the (sensing) signal itself. This is required to make sure that the receiver can decode the information.

In embodiments, in addition to the modulations representing their data, the backscatter tags may further modify the frequency of the backscattered signal using knowledge of the chirp parameters selected from the codebook. In principle the backscatter tags may perform many forms of modification so long as it is known to the base station (and/or cooperative receiver). This may be specified in the codebook or may form part of another shared standard.

As already mentioned above, the backscatter tags may attempt to apply a frequency shift opposite to the selected frequency from fs applied by the base station, to thereby compensate the selected frequency shift fs (i.e., generating returns which do not shift in frequency, even when the selected frequency shift fs is applied by the base station). In other embodiments, the backscatter tags may take other actions, such as enhancing the frequency shift or only cancelling part of the shift e.g. to distinguish their returns from those of passive objects.

In embodiments, the reception of the (reflected/backscattered) wireless sensing signals (return signals) may be achieved by a classification function (provided e.g. at the demodulation function), where the base station receives the return signals and classifies them as returns from passive objects or backscatter returns. In examples, the classification may be achieved, e.g., according to the modulated data, e.g., whether the frequency and apparent Doppler shift changes by the introduced frequency shift fs between adjacent chirps or chirp groups. The logic used by the demodulation function may depend on the precise compensation/modulation applied by the backscatter tags.

In an example where the backscatter tags apply an own frequency shift opposite to the frequency shift fs selected from the codebook, thus cancelling it, the demodulation function may be configured to apply the following classification rules:
(i) If the apparent Doppler frequency changes between returns generated from chirps that had an applied frequency shift fs, then the received return is from a passive object. There may be an additional frequency shift caused by the Doppler shift due to the passive object's velocity, but this would not be expected to change along with the applied frequency shift fs.
(ii) If the apparent Doppler frequency does not change between returns when there has been a frequency shift fs applied to the transmitted waveform, then the return is from a backscatter tag.

In other cases, where the backscatter tags have taken some other identifying modulation action (for example, enhanced the frequency shift fs or compensated only part of the frequency shift fs), then the demodulation function may check for the presence of that modulation on returns generated from the shifted chirps of the transmitted waveform.

As regards the subsequent processing of backscatter returns, the classification function may pass the backscatter returns to a downstream function (e.g., a network function) which demodulates the data transmitted by the backscatter tags and takes any appropriate further action (such as forwarding messages to a user/owner of the tags).

For returns classified as originated from passive objects, the received reflected signal may be passed to the normal processing pipeline for wireless sensing. For instance, in the case of a chirp signal, if high-velocity passive objects are sensed with large Doppler shifts (i.e., large enough to be aliased at the employed chirp repetition rate r), the technique of Wei Wang et al.: “Multi-Target Detection Method Based on Variable Carrier Frequency Chirp Sequence”, Sensors 2018, 18(10), 3386; https://doi.org/10.3390/s18103386, may be used, i.e., using the shifted chirps containing an applied frequency shift fs as a second, independent waveform, to resolve any resulting Doppler ambiguities, and to calculate the range and Doppler shift of all Passive Objects (including the moving ones).

Alternatively, if no high-velocity passive objects are present, a simpler implementation may be to simply remove the additional artificial frequency shift fs which was applied by the base station on the transmitted waveform to allow calculation of true range and Doppler shift of the passive object using conventional radar techniques.

In a further embodiment, a Van-Atta array may be used by the backscatter tags so that they retro-reflect, i.e., reflect in the direction of the incoming signal. Thereby, a co-operative UE may not actually see the backscatter returns, but it would still see clutter returns. This effect can be used to differentiate between (returns from) backscatter tags and (returns from) passive objects. As the co-operative UE would probably also receive the original waveform (e.g., chirp) and timing from the transceiver device, it might be able to perform its own demodulation/processing using the received original waveform as reference.

In some embodiments, instead of using a codebook to indicate the parameters of the wireless sensing signal, this may be done explicitly or implicitly, i.e., by explicitly or implicitly indicating the parameters (e.g., time resources, frequency resources, etc.) of the wireless sensing signal. Here, “explicit” means that the codebook identifier or the actual resources of the wireless sensing signal are transmitted, while “implicit” means that the parameter information is exchanged by means of other parameters, e.g., the aspect of the wireless sensing signal or other fields in it. Implicit transmission reduces the communication overhead. Explicit transmission reduces the computational complexity of the receiver.

In some cases, it may be desirable to perform wireless sensing of objects that are not suitable for wireless sensing (e.g., small objects or objects that do not reflect wireless sensing signals well, such as e.g., a cat or a small non-metal object) and/or better identify such objects and/or better sense such objects. Such a need may be addressed by means of embodiments in which such objects may have a backscatter tag (e.g., attached to them), whose function is to amplify/enhance the returned wireless sensing signal in such a way that sensing/identification is facilitated.

For instance, in a related embodiment, the backscatter tag may be attached to an object (e.g., carried by a small cat) and the application goal may be to determine a feature of the object (e.g., measure the breathing rhythm of the small cat or another health parameter). The backscatter tag may thus have an integrated sensor, e.g., an accelerometer. The backscatter tag then modulates the measured feature on the received wireless sensing signal. This may have as an effect that the backscattered signal has an amplified strength of the measured breathing rhythm, which needs to be compensated at the demodulation function where the backscattered signal is processed.

In a related embodiment, the backscatter tag may frequency shift the received wireless sensing signal dependent on a measured acceleration of the backscatter tag. In examples, the backscatter tag may measure the incoming wireless sensing wave Wa, measure a wireless sensing wave Wb (weakly) reflected by a passive object, backscatter Wa as a return wave Wc, where Wc is modulated to match/mimic Wb. As an example, the backscatter tag may backscatter Wc only if Wb is too weak or if Wc matches Wb with a minimum accuracy where the minimum required accuracy may have been configured by a managing entity (e.g., the base station or a network function). For instance, in a related embodiment, the tag may embed information in the modulated data of the backscattered signal about the fact that it is facilitating wireless sensing of a “small” object.

In some situations, it may not be desirable that a backscatter tag reacts to all received wireless sensing waves. This may be because the backscatter tag is not authorized to use them or because the system does not want to overload the RAN with answers.

This need can be addressed by the following embodiments.

In a first embodiment, the backscatter tag may receive a configuration determining which wireless sensing waves or configuration parameters of the wireless sensing waves are authorized to be used by the backscatter tag.

In a second embodiment, the backscatter tag may be capable of monitoring the type or configuration parameters of a wireless sensing wave (e.g., frequency range, timing, etc.) and may determine whether it is authorized to backscatter the wireless sensing wave. The backscatter tag then proceeds to backscatter the received wireless sensing wave only if it is authorized.

In some situations, the managing entity, e.g., base station, may not be aware of the best wireless sensing wave (parameters) to use in a given environment and/or context. This can lead to a situation in which unsuitable parameters are used, causing worse performance either in terms of the amount of resources used (over-use) or in the quality of the sensed information.

This problem can be addressed by an embodiment where the wireless sensing waveform is adjusted based on the backscatter tags and/or passive objects in the cell. To achieve this, the base station may initially select a wireless sensing waveform (e.g., chirps) of a smaller bandwidth and may then evaluate whether the selected sensing waveform is sufficient or insufficient for a current situation (i.e., does not support enough concurrent backscatter tags and/or resolution of radar sensing is not high enough). If insufficient, the base station may increase the bandwidth to a higher bandwidth. If sufficient, the base station may decrease the bandwidth to a lower bandwidth. In general, this can be implemented by an adaptive system in which a managing entity (e.g., base station or a network function) adapts the wireless sensing wave parameters to fulfil the application needs in a given region of interest while minimizing the usage of wireless resources.

In another embodiment, the wireless sensing waveform may be adjusted based on an external distance estimation technique. To achieve this, the managing entity (e.g., base station or network function) may determine the parameters of the wireless sensing waveform. These parameters may depend on, e.g., how far or how fast the backscatter tags and/or passive objects are or move, respectively. The managing entity (e.g., base station or network function) may then use the external distance estimation technique to determine the parameters of the wireless sensing wave.

In an example, this external estimation technique may be the timing advance of mobile devices (e.g., UEs) that are in the region of interest and are or can be associated to at least one target object (e.g., a backscatter tag or a passive object). For instance, if the managing entity is aware of a mobile device associated to a given timing advance value, and the managing entity wishes to monitor the at least one target object, then the managing entity may take into account this timing advance to configure and/or select parameters of the wireless sensing wave.

As regards localization (positioning) of backscattering tags, the receiver (e.g., the base station) of a backscattered can retrieve the distance from the receiver to a backscatter tag based on the received signal as follows:

For backscattering, a backscatter tag may modulate the signal, e.g., FSK-modulates the backscattered signal with a predetermined frequency, e.g., f1. The fact that the backscatter tag FSK-modulates with f1 may interfere with a positioning approach of wireless sensing, in particular, in case a radar-based system is used. However, if the backscatter tag also includes information about the used frequency f1 in the backscattered signal, e.g., if this information is encoded or modulated in the backscattered signal itself, then the receiver knows that the received signal is modulated with f1. If there is a sender (i.e., transceiver (TRX)) and three receivers (e.g., a TRX distributed unit (DU) and two Rx DUs, where the RX DUs are synchronized with the TRX DU), then the sender (TRX DU) can send the wireless sensing signal, each of the Rx DUs can receive the backscattered return from the backscatter tag, each of the Rx DUs can learn the fact that it is f1-modulated, remove the f1 factor, and obtain the distance to the backscatter tag. The location of the backscatter tag can then be obtained by one of the DUs, the central unit (CU), or a network function by means of trilateration from the three measured distances.

However, the returns from the backscatter tags may include information identifying the backscatter tag. For instance, if a backscatter tag FSK-modulates the return signal, then the FSK modulation can be used to identify the backscatter tag. For instance, if the backscatter tag inserts an identifier by modulating the received wireless sensing signal, then the identifier can be used to identify the backscatter tag, which may pose a privacy risk. This may also allow an attacker to create fake tags that confuse a receiving party (e.g., base station) about which backscatter tags are actually present in a cell.

In order to address these privacy problems, the following embodiments may be applicable, either standalone or combined (where applicable), to protect the identifier:

In a first embodiment, the backscatter tag may apply a modulation and/or embed an identifier that depends on an input value included in the transmitted wireless sensing waveform. For instance, the wireless sensing waveform may include a challenge as an input value (e.g., encoded in the beginning of the wireless sensing signal). The backscatter tag may then compute a response to the challenge, e.g., as a cryptographic function of the challenge (e.g., a hash-based message authentication code (HMAC), encryption or the like) by using a cryptographic key linked to the identity of the backscatter tag. The response can then be used to modulate the received wireless sensing signal during backscattering.

In a second embodiment, the backscatter tag may apply a modulation and/or embed an identifier that is time-dependent, e.g., when backscattering a received wireless sensing signal, it may include modulated data obtained as the cryptographic function (e.g., HMAC) of a key and a counter that may be based on the Coordinated Universal Time (UTC). The modulated data may include the least significant bit (LSB) of the UTC-based counter and the output of the cryptographic function.

In a third embodiment, the receiver of the backscattered signal (e.g., a base station) may use the received response to determine/identify the backscatter tag by using the modulated data and a list of authorized backscatter tags.

In a fourth embodiment, an authorized backscatter tag may be configured with a cryptographic key. Keys of authorized backscatter tags may also be configured in the managing entity, e.g., base station or network function.

In a further embodiment that may be combined with other embodiments, backscatter tags may be configured to operate with “backscattering occasions” where backscattering occasions are the time slots that are allocated to certain tags to backscatter signal. This can serve to reduce the interferences in the system/coordinate many tags. In this embodiment, a backscatter tag may know its identity (that may be a pseudonym or a temporary identity or a challenge as in previous embodiments) and derive from it the instants of time in which it may receive a (sensing) signal to be backscattered. The signal may embed itself the pseudonym of the backscatter tag. When present, and optionally, when verified (as in the case of a challenge), the backscatter tag may backscatter back the received signal. This backscattering action may trigger the allocation or usage of a new pseudonym.

To summarize, a system and method have been described, by which wide area backscatter communications can be enabled on top of an existing ISAC waveform, without introducing Doppler ambiguities, by modifying wave form parameters such as the chirp start and stop frequencies between adjacent (or at least, groups of n) chirps according to a codebook.

While the invention has been illustrated and described in detail in the drawings and foregoing description, such illustration and description are to be considered illustrative or exemplary and not restrictive. The invention is not limited to the disclosed embodiments. It can be applied to various types of mobile devices for backscattering or as cooperative receivers, such as mobile phone, vital signs monitoring/telemetry devices, smartwatches, detectors, vehicles (for vehicle-to-vehicle (V2V) communication or more general vehicle-to-everything (V2X) communication), V2X devices, Internet of Things (IoT) hubs, IoT devices, including low-power medical sensors for health monitoring, medical (emergency) diagnosis and treatment devices, for hospital use or first-responder use, virtual reality (VR) headsets, etc.

The base station may be any network access device (such as a base station, Node B (eNB, eNodeB, gNB, gNodeB, ng-eNB, etc.), access point or the like) that provides a geographical service area.

While a chirp signal is used in the above embodiments, the invention is applicable to other sensing signals such as an OFDM-based sensing signal.

Furthermore, at least some of the above embodiments may be implemented to provide enhanced network functions and equipment for 5G/6G/xG cellular networks.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.

At least some steps of the described operations like those indicated in FIGS. 2 and 3 can be implemented as program code means of at least one computer program and/or as dedicated hardware of the related network device or function, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus comprising:
a processor circuit and a memory circuit, wherein the memory circuit is arranged to store instructions for the processor circuit,
wherein the processor circuit is arranged to transmit a wireless sensing signal,
wherein the processor circuit is arranged to receive a wireless return signal from the network,
wherein the processor circuit is arranged to classify the wireless return signal into a passive object return signal or a backscattered return signal or a backscatter-enhanced passive object return signal,
wherein the processor circuit is arranged to process the return signal according to the classification result.

2. The apparatus of claim 1,
wherein the processor circuit is arranged to select a wireless sensing waveform configuration from a codebook,
wherein the processor circuit is arranged to transmit the wireless sensing signal with a waveform according to the selected wireless sensing waveform configuration.

3. The apparatus of claim 2, wherein the processor circuit is arranged to modify chirp start and stop frequencies between one or more adjacent chirps according to the codebook.

4. The apparatus of claim 2, wherein the processor circuit is arranged to pre-configure or configure a backscatter device based on the selected wireless sensing waveform configuration or an available wireless sensing waveform configuration.

5. The apparatus of claim 2, wherein the processor circuit is arranged to select the wireless sensing waveform configuration based on one of an external distance estimation technique and an information about backscatter devices and/or passive objects in a region of interest of the wireless network.

6. The apparatus of claim 5, wherein processor circuit is arranged to use the external distance estimation technique to estimate a distance to the furthest backscatter device in the region of interest of the wireless network.

7. An apparatus comprising:
a processor circuit and a memory circuit, wherein the memory circuit is arranged to store instructions for the processor circuit,
wherein the processor circuit is arranged to receive or retrieve a configuration of a wireless sensing waveform of an integrated sensing and communication system,
wherein the processor circuit is arranged to determine a reception of the wireless sensing waveform based on the received or retrieved configuration,
wherein the processor circuit is arranged to backscatter the received wireless sensing waveform.

8. The apparatus of claim 7,
wherein the configuration comprises a codebook,
wherein the codebook comprises active wireless sensing waveforms and corresponding parameters of the integrated sensing and communication system.

9. The apparatus of claim 7, wherein the processor circuit is arranged to determine the reception of the wireless sensing waveform using at least one of:
measuring at least one parameter of the wireless sensing waveform and determining based on the measuring result whether the wireless sensing waveform corresponds to the received or retrieved configuration; and
comparing an identifier encoded in the wireless sensing waveform with a corresponding information of the received or retrieved configuration.

10. The apparatus of claim 7, wherein the processor circuit is arranged to modulate the backscattered wireless sensing waveform to match a wireless sensing waveform redirected by a passive object.

11. The apparatus of claim 7, wherein the processor circuit is arranged to modulate the backscattered wireless sensing waveform to include a protected identifier.

12. (canceled)

13. (canceled)

14. (canceled)

15. A method comprising:
transmitting a wireless sensing signal;
receiving a wireless return signal from the network;
classifying the wireless return signal into a passive object return signal or a backscattered return signal or a backscatter-enhanced passive object return signal; and
processing the return signal according to the classification result.

16. A method comprising:
receiving or retrieving a configuration of a wireless sensing waveform of an integrated sensing and communication system;
determining a reception of the wireless sensing waveform based on the received or retrieved configuration; and
backscattering the received wireless sensing waveform.

17. A non-transitory computer-readable medium storing a computer program, wherein the computer program when executed on a processor performs the method as claimed in claim 16.

18. The apparatus of claim 16,
wherein the configuration comprises a codebook,
wherein the codebook comprises active wireless sensing waveforms and corresponding parameters of the integrated sensing and communication system.

19. The apparatus of claim 16, further comprising determining the reception of the wireless sensing waveform using at least one of:
measuring at least one parameter of the wireless sensing waveform and determining based on the measuring result whether the wireless sensing waveform corresponds to the received or retrieved configuration; and
comparing an identifier encoded in the wireless sensing waveform with a corresponding information of the received or retrieved configuration.

20. The apparatus of claim 16, further comprising modulating the backscattered wireless sensing waveform to match a wireless sensing waveform redirected by a passive object.

21. The apparatus of claim 16, further comprising modulating the backscattered wireless sensing waveform to include a protected identifier.

22. The apparatus of claim 15,
further comprising selecting a wireless sensing waveform configuration from a codebook; and
further comprising transmitting the wireless sensing signal with a waveform according to the selected wireless sensing waveform configuration.

23. The apparatus of claim 22, further comprising modifying chirp start and stop frequencies between one or more adjacent chirps according to the codebook.

24. The apparatus of claim 22, further comprising configuring a backscatter device based on the selected wireless sensing waveform configuration or an available wireless sensing waveform configuration.

25. The apparatus of claim 22, further comprising selecting the wireless sensing waveform configuration based on one of an external distance estimation technique and an information about backscatter devices and/or passive objects in a region of interest of the wireless network.

26. The apparatus of claim 25, using the external distance estimation technique to estimate a distance to the furthest backscatter device in the region of interest of the wireless network.

27. A non-transitory computer-readable medium storing a computer program, wherein the computer program when executed on a processor performs the method as claimed in claim 15.
